(19) United States
(12) Patent Application Publication
(10) Pub. No.: US 2014/0329497 A1
(43) Pub. Date: Nov. 6, 2014

(54) Smartdevices Enabled Secure Access to Multiple Entities (SESAME)

(71) Applicants: Ameya M Sanzgiri, Buffalo, NY (US); Anandatirtha Nandugudi, Buffalo, NY (US); Shambhu Upadhyaya, East Amherst, NY (US); Chunming Qiao, Williamsville, NY (US)

(72) Inventors: Ameya M Sanzgiri, Buffalo, NY (US); Anandatirtha Nandugudi, Buffalo, NY (US); Shambhu Upadhyaya, East Amherst, NY (US); Chunming Qiao, Williamsville, NY (US)

(21) Appl. No.: 13/887,280

(22) Filed: May 4, 2013

(51) Int. Cl. H04W 12/06

(52) U.S. Cl. CPC H04W 12/06
USPC 455/411; 455/26.1

(57) ABSTRACT

This invention proposes novel systems, methods and apparatus that utilize smart devices (e.g., smartphones) capable of reading/processing biometric inputs, and wireless communications over secure, short-range wireless channels (e.g., near field communications (NFC)) to securely access websites and cyber-physical system (CPS) entities such as vehicles, rooms and control knobs as well as sensors and smart meters. A user accesses a website on a display terminal or CPS entity by using her smart device to send her biometric credentials to request access for a service, and communicates with either the said terminal or the said CPS entity which is also capable of short-range wireless communications, using secure and short-range wireless channels to ensure the authenticity of the user when using the service. This system also protects the stored credentials of the user against loss or theft of the smart device since the credentials are encrypted by the user's biometrics, and the stored credentials on the smart device can only be accessed by a legitimate user using her biometrics.

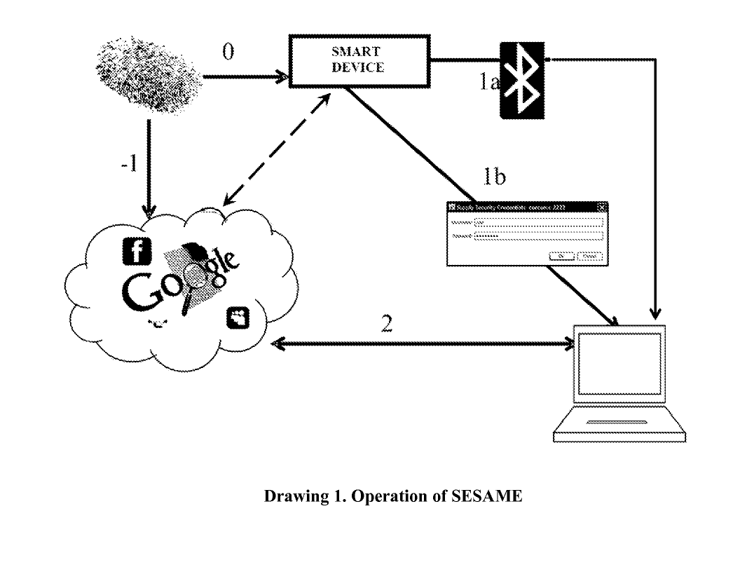

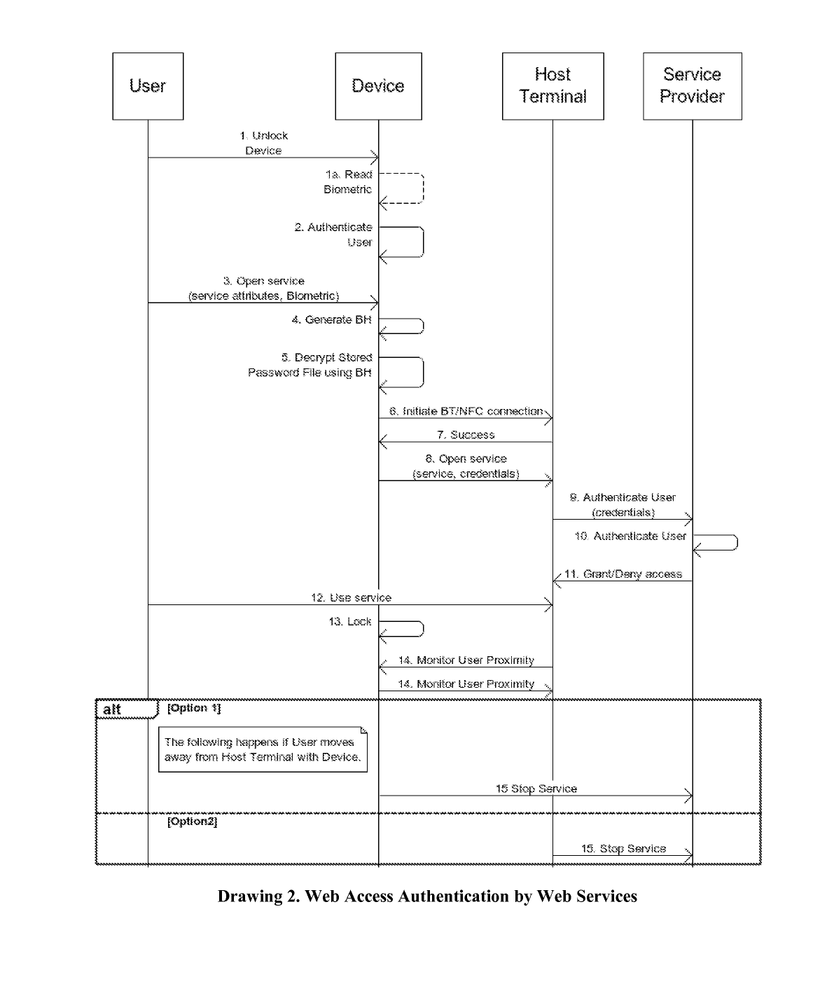

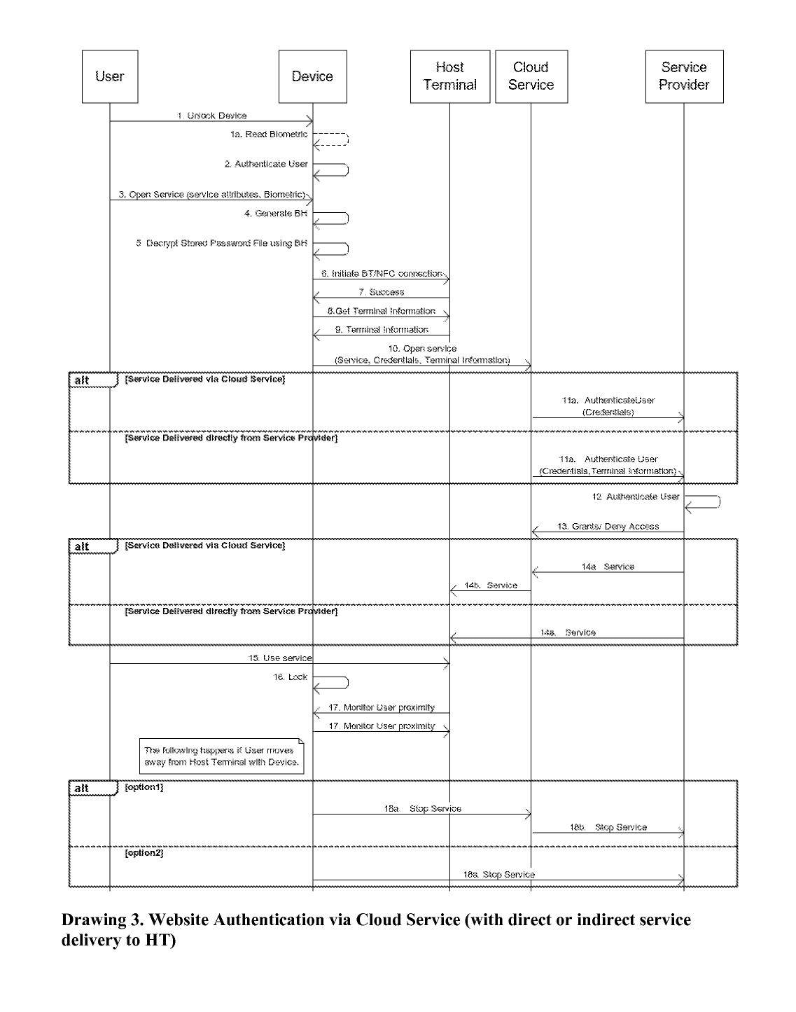

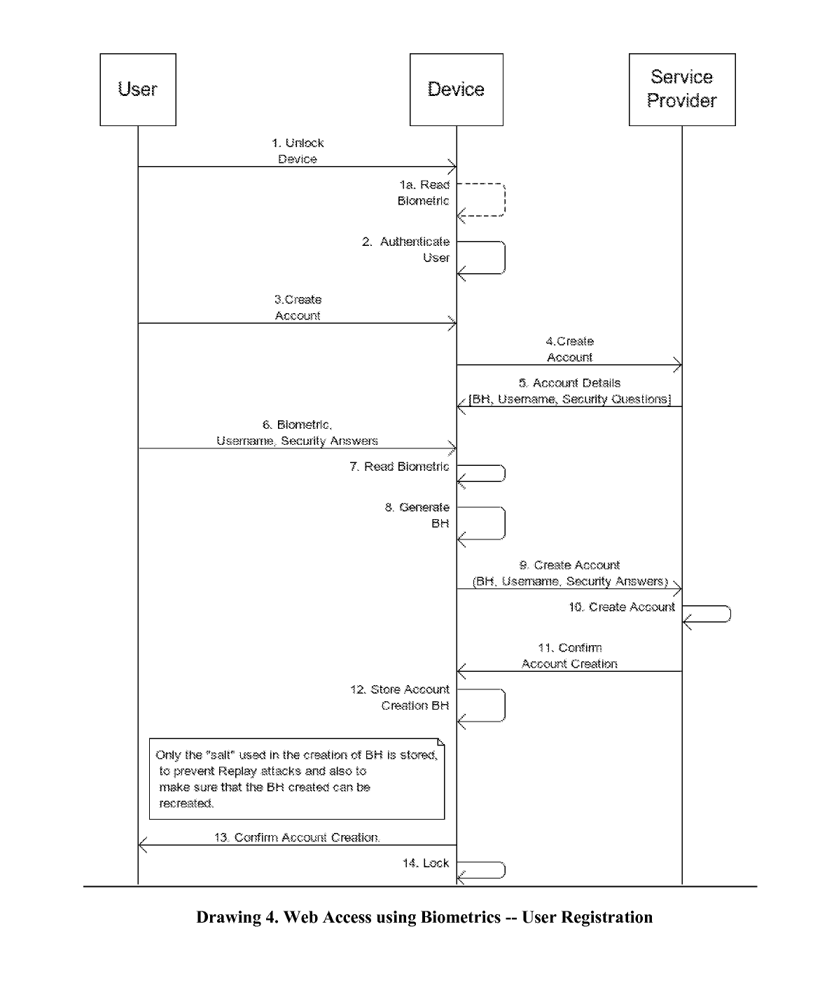

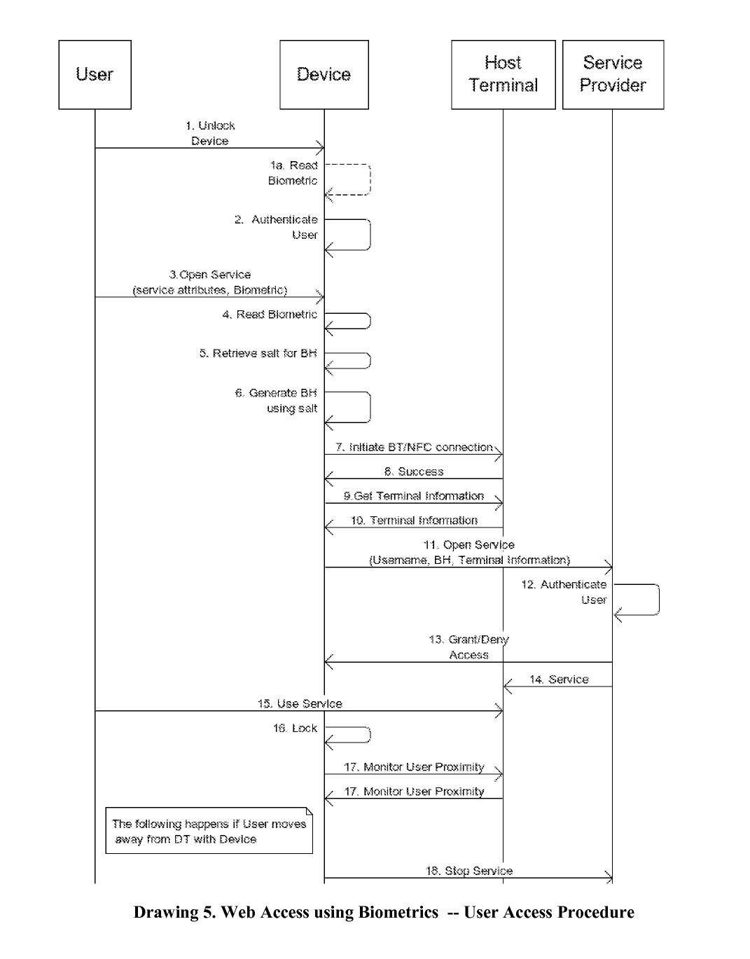

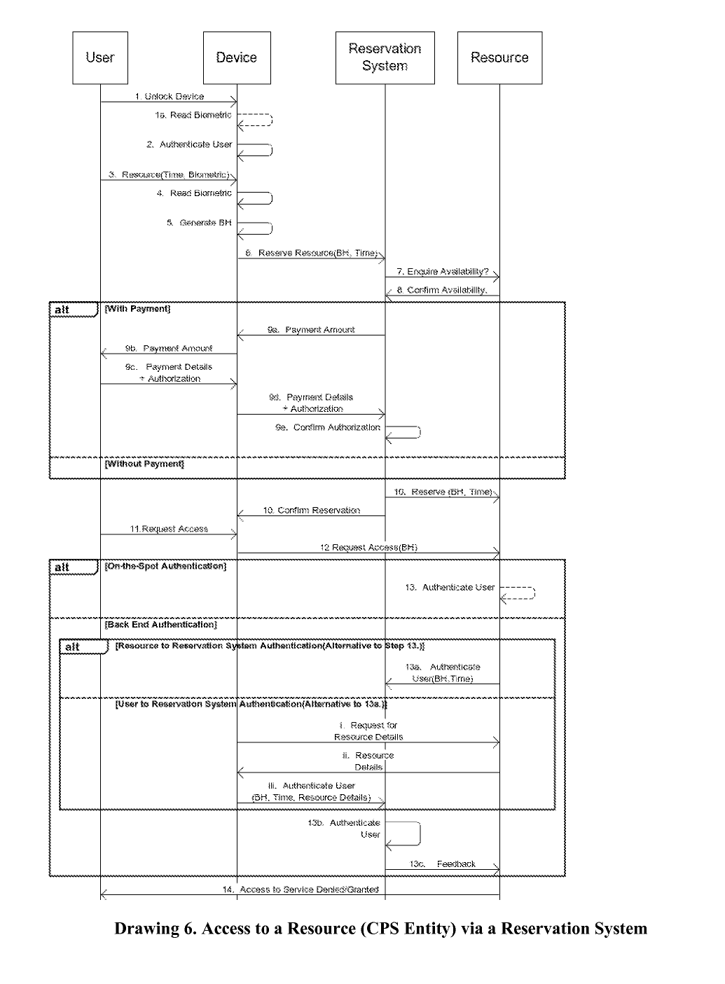

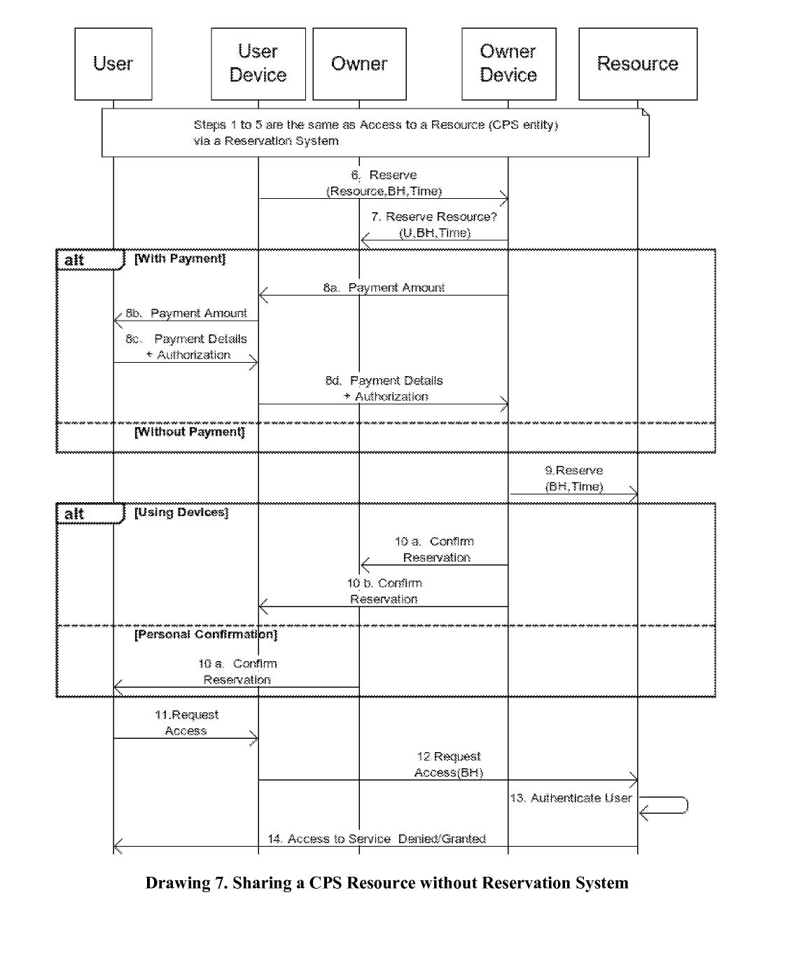

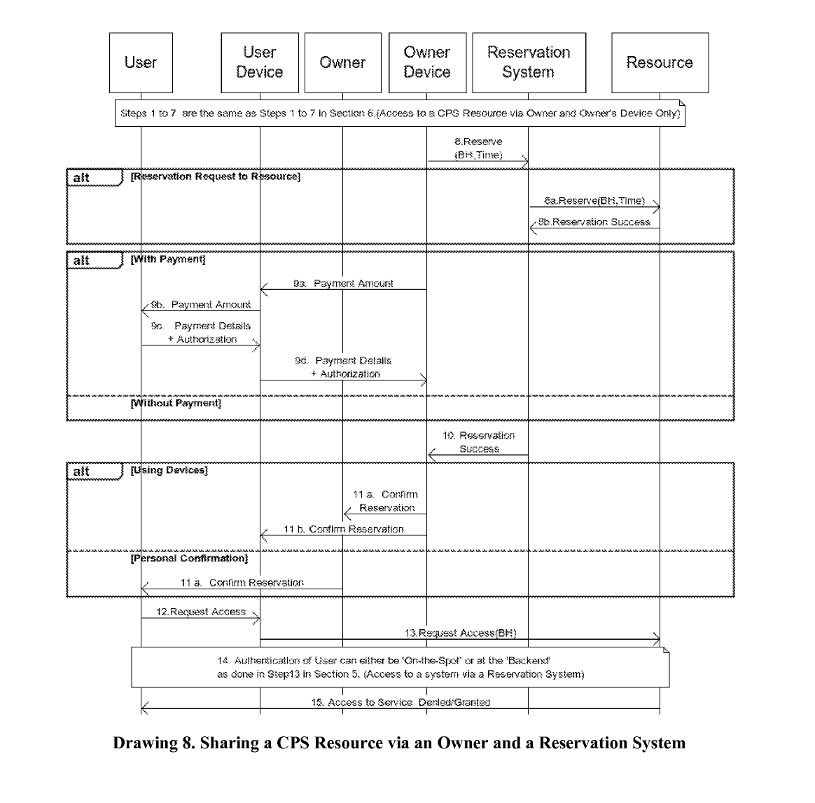

### RELATED APPLICATIONS

This application claims priority to Provisional Patent Applicant, Ser. No. 61/642,530, filed May 4, 2012.

### FIELD OF INVENTION

The invention pertains to securely access to websites or other cyber-physical assets. The invention is also directed towards using smart devices (e.g., smartphones) capable of reading/processing biometric inputs, and wireless communications over secure, short-range wireless channels (e.g., near field communications (NFC)) to securely gain access to websites and cyber-physical system (CPS) entities and control them. CPS entities in general are assets whose access is controlled by a lock mechanism such as vehicles, rooms and control knobs as well as sensors and smart meters. This invention also relates to improvising the means for reducing the risk of misuse of assets, and for protecting related apparatus, including measures to minimize leakage of credentials, identity theft and other forms of fraud.

### BACKGROUND OF THE INVENTION

Most Internet services like email, e-banking and social networking implement access control via a username\password based authentication scheme. Recently, new classes of passwords such as Graphical, Haptic and Visual have been proposed to replace textual passwords which are plagued by human fallibility. While promising and efficient in standalone applications, these new class of passwords are not likely to be used in the foreseeable future, due to the requirement of new hardware, usage education and interoperability with current systems. Textual passwords thus are likely to remain at least for now as the only way to authenticate a user to web services. However, an adversary, by gaining knowledge of a user's password (e.g., by brute force attack), can compromise a user's access to such services. This concern can be largely alleviated by having users choose strong and complex passwords (which have high information entropy) for authentication. In fact, some Service Providers have enforced password creation policies to make users choose such strong and complex passwords.

However, there are two inherent issues with users being forced to choose stronger (or complex) passwords. First, studies such as [1]-[4] have indicated that enforcing stricter password rules causes users (almost 50% according to [5]) to take shortcuts like writing down the complex password in clear text, either on paper or electronically, as a memory aid.

Thus, it is easy for an adversary to get hold of the complex password[1],[6]-[8].

The second issue with complex passwords is the reuse or recycle of the same password for different services since remembering different passwords is burdensome. More than 34% of the people reused the exact password while almost 18% reused them with minor modifications [5]. The study in [9] also found that 41% of accounts from a university system could each be cracked in three seconds, using the knowledge of their expired passwords. A malicious entity can thus easily crack a user's password if she has the knowledge of password composition trends by the user or (and) if passwords are reused.

To add to this, the risk of compromising her password either from shoulder surfing techniques [10] or key loggers on end systems always exists, especially in public places or systems [11]-[12]. In shoulder surfing, an adversary is able to watch a user keying in her credential by visually recording the user's keystrokes. Keyloggers are programs or hardware devices that record all keyboard strokes.

However, the most serious problem today is that current authentication systems have no mechanisms to recognize the identity of the person who enters the password; in other words, there is no way of verifying if the person presenting the credentials is actually the person that she is claiming to be. Since the communication channels can be secured using protocols such as https, SSL, TLS, the weakest link which controls a user's access to web services today is the human factor [13] due to the need of entering passwords.

Similarly, access to Cyber physical system to authorized personnel is controlled using smart card readers or physical keys to provide access to the CPS entity. However, any unauthorized person can gain access to the CPS entity by gaining possession of the smart card or the physical key that provides the access to the CPS entity.

Currently, in order to incorporate a new authentication schemes, such as using a person's biometric attributes like fingerprint, iris scan etc., to existing authentication schemes to access websites or CPS entity would require a change in the present internet architecture or installation of readers that is capable of reading a person's biometric attributes like the fingerprint. It is not feasible to achieve this.

This invention addresses these problems by incentivizing the usage of strong passwords effortlessly, tying up a user's digital identity to her physical identity and assimilating emerging technologies such as smartdevices (capable of reading and processing the user's biometric inputs) the and cloud services into current existing technologies to realize a secure system, capable of securely accessing websites or other cyber-physical assets.

### DESCRIPTION OF RELATED ART

Securing access to an asset is a well-known problem and a lot of solutions have already been proposed. Particularly, U.S. Pat. No. 8,0037,511, US 2009/0158032, US 2006/0224901, and U.S. Pat. No. 7,5552,467 have proposed approaches/ solutions for securely accessing assets using mobile phones or similar devices. In the following paragraphs, we describe how our approach differs from them.

In the case of U.S. Pat. No. 8,0037,511, the invention uses a mobile phone as additional authentication mechanism to web services and assets. In the scenario of accessing web service, a user has to register her phone to a service, apart from username/password credentials for authentication. This is so that secondary authentication details can be provided/processed via the mobile phone, this thus forces a user to always have the mobile phone to access the webservice. Second, any unauthorized user who gains possession of the registered phone can use it to authenticate her to the web service. In our invention first no such registration is necessary, providing the user with the convenience of not always having the smartdevice on her person and allowing access to services in case the smart device is not operational for any reason. Second, our invention also mandates that a user has to authenticate herself to her smart device via biometrics. This prevents unauthorized access to services in cases where the user loses or misplaces her device. Further, our invention also requires that the credentials of a user are stored on a smartdevice, which further minimizes the threat of identity or credential theft. Another important distinction of our invention from U.S. Pat. No. 8,0037,511 is that there is no need for changes to existing service providers (such as service providers requiring to process additional authentication mechanisms) or architectures. Our invention can be used on top of existing architectures perfectly. Further, the use of additional authentication factors also increases the chance of compromise as there are more avenues to exploit. Finally, our invention also addresses the security scenarios after a user has successfully authenticated to web services. In our invention after successful authentication a user is leashed to the host terminal via Bluetooth. If a user walks away from the host terminal with her smart device, the user is automatically logged out of the service and re-accessing the service requires the user to authenticate again.

In the scenario of Cyber Physical Systems or assets, our invention allows flexibility of user-specific authentication (say, more than one biometric attribute) as opposed to the keyless entry concept provided by U.S. Pat. No. 8,0037,511. Further, our invention allows access to systems via a reservation system which in case of personal assets such as cars, apartment access, etc. eliminates the need of an owner to be involved during the authentication process. However, in such cases the owner needs to be involved in the reservation process. As before, our invention uses biometrics exclusively for accessing physical assets thus minimizing unauthorized access.

US 2009/0158032 also presents a method for securing access to online services to users of mobile communication terminals, however their solution is aimed more towards the workings of securing access to mobile data networks and wireless mobile data networks. Our invention assumes that the access to data networks is already secured.

US 2006/0224901 provide a solution aimed at using mobile devices in an access control system. Specifically, the invention aims at controlling access to assets, places or things by having credentials remotely assigned and revoked. The difference between their invention and our invention is two-fold; first, they do not use biometrics for authentication, which increases the risk of unauthorized access to assets. Second, access control rules are sent to the mobile device instead of the CPS entity, which is a dumb tag and only transmits its identity. The controller updates the access information on the user's device, which reads the identity of the CPS entity/asset and determines if it (and thus, the user) has access to the entity based on the access control rules. In our invention, the CPS entity processes the credentials presented to it and it determines if the user has access to it, which again minimizes risk of unauthorized access.

U.S. Pat. No. 7,5552,467 present a solution that is aimed more at user interfaces for configuring access criteria and security rules responsive to primary and secondary passwords. Thus the said invention aims more at

### SUMMARY OF THE INVENTION

The following paragraphs describe the methods used for authenticating users for access control to assets and services, which include web based services as well as cyber-physical entities.

The primary approach is to allow users gain access to services by authenticating to service providers using their smart devices. Smart devices in addition to possessing the processing capability and memory that rival modern computers also have optimized modules to efficiently use their limited energy, thus providing longer standby time. Many smartphones like the Motorola Atrix, come equipped with biometric sensors like fingerprint readers as well as features such as face-unlock, to authenticate the use of the smartphone. With the use of smart devices, the need for setting up dedicated Biometric authentication is not required, hence circumventing its major drawback of costly installations.

In case of accessing web based services, a user will want to access the web services on a Host Terminal (HT). Here the Host Terminal is used to view the web content. The user uses her smart device to connect and communicate to the HT using a short range wireless communication such as NFC, BlueTooth etc., and uses the short wireless communication protocol to securely transfer her credentials to the HT which then forwards it to the required web service. The flow of information from the Host Terminal to the web server is securely processed via Internet protocols. Similarly, the authentication mechanisms and schemes at the web server are unchanged. Thus the inventions approach also mainly addresses the interaction between a user and the Host Terminal for accessing services. Specifically, we address the problem of inputting credentials via a Host Terminal to access a service. Incidentally, addressing this specific problem also addresses the limitation of memorizing textual passwords. SESAME provides an avenue that is complimentary to textual passwords and their usage, mainly providing a way to better support its use while removing their limitations. A user during the registering process for a web service chooses a strong password. She then stores her credentials for the service (username and strong password) on a smart device by manually entering this information. Whenever she has to access the web service, she will securely transfer the credentials from her smart device to a Host Terminal or a cloud service which will then forward her credentials to the appropriate Service Providers. The Service Provider authenticates the user and delivers the service to the Host Terminal. This concept can also be extended to the use of biometrics as credentials for authentications. In this approach, the user uses the smart device to input, process her biometric information and registers the processed biometric attribute as the authentication credential with a web service. Whenever the user wants to access the web service the user now presents her biometric information via the smart device as authentication credentials. The webservice processes the biometric information and accordingly grants or denies access to the user.

In case of the Cyber Physical Systems (CPS), the overall approach still holds true. Any user wanting to access a service will use her biometric exclusively as her authentication credential. The user when accessing her service will have to save her biometric attribute on a smart device as credentials. The user will then user her smart device to communicate with the CPS entities and using short range wireless communication such as NFC, transfers her credentials for authentication. The CPS Entities then can process the credentials and accordingly grant or deny access to the user. This particular approach can also be used by a user to reserve access to a CPS entity, where initially the user can send across her biometric attribute as a registration token/credential to the service provider or owner of the service. At the time of using the service, the user follows the same method to authenticate herself to the service provider.

### DESCRIPTION OF THE DRAWINGS

Drawing 1 depicts the operation of SESAME, with numbered lines describing the order in which a user has to use SESAME to gain access to a website or a CPS object.

Drawing 2 describes the apparatus and method for user wanting to access a web service and how the web service provider (or any service provider) can authenticate her.

Drawing 3 describes the apparatus and method for a user wanting to access a web service in the presence of a cloud service, how the web services (or any service provider) can authenticate the user and how the web service can be delivered to the user. In presence of the cloud service, the web service can deliver the required service to the user either via the cloud service or directly from web service to the user.

Drawing 4 depicts the system and method for a user to register her biometrics (used as credentials) with a Web service (or any service provider).

Drawing 5 depicts the system and method how a web service (or any service provider) authenticates a user when a user has already registered her biometrics with a web service (or any service provider) and wants to access a service.

Drawing 6 depicts the system and method to securely reserve and access a physical entity in the presence of a reservation service. It also depicts the authentication of a user in such a scenario.

Drawing 7 depicts the system and method to securely sharing a CPS resource or asset in the absence of a reservation system. This system primarily caters to sharing of personal physical resource or assets of an owner.

Drawing 8 depicts the system and method to securely access a CPS resource or asset in the presence of an owner and a reservation system. The drawing also depicts authentication methods.

### DETAILED DESCRIPTION OF INVENTION

Reference will not be made to several embodiments of the invention with examples of scenarios, described here and illustrated in the drawings.

The following are the definitions of some basic objects along with their notations in parentheses, that will be recurring from here on.

User (U) and User's smart device (D) e.g., smartphone, which is capable of reading/processing biometrics. An owner (O) of a CPS entity is also considered as a user when she wants to use the entity (instead of letting others to use the entity).

User Agent: this could be another human e.g., the owner (O) of a CPS entity, or a software agent as a part of the cloud service (CS).

Service (S) e.g., websites for E-mail, E-Commerce, Social Networks, or Resource (R) e.g., CPS entities.

Service agent: this could be a Service Provider (SP) e.g. web servers or a resource management/reservation system (RS) used for CPS entities.

Near Field Communications (NFC) interface or any other short range wireless communication mechanism such as Bluetooth.

Biometric Hash (BH) generated by the user's smart device (D) with user's biometrics U_{BIOMETRIC} and a “salt” used to add certain randomness to the BH.

Other definitions will be made as and when the embodiments require their usage. We first describe the embodiments of a Website access system and then the embodiments of CPS access systems.

### I. Website Access Systems

Drawing 2, depicts a access system for a web service operated by a service provider (SP). The access system comprises of user U, her smartdevice D (which adheres to the definitions/requirements mentioned above) and an electronic device (or other embodiment of a client) with capability of connecting to the service provider over the Internet or other data communication networks, such as a computer with short range wireless communication interface, here marked as the host terminal (HT). The host terminal is used to process the service provided by the service provider, only if the user is authenticated to the access the service. The service provider may be using security services or servers to confirm authentication credentials. We assume that U already has stored her strong password/credentials (CR_{STORED}) on D along with the service attributes for each service. D stores the credentials (or any other embodiment of credentials) what herein will be referred to as a password file and encrypts it using a BH created from a user biometric (U_{BIOMETRIC}). We also assume that U has stored on D, her BH (from U_{BIOMETRIC}) that is used to authenticate U to D.

U first presents her biometric attribute (such as a fingerprint scan/face unlock or any other embodiment of the same) to D which reads the Biometric input, calculates the Biometric hash (BH) and compares it with U_{BIOMETRIC}. On successful comparison, D is unlocked. If U uses other means of locking the smart device such as a pin code, graphical passwords etc., U has to present them for D to be unlocked. The user then provides to D the attributes of a service such as the service name or identifying information (or any other embodiment of such attributes) as well the biometric required decrypting the password file that contains the credentials necessary to access the service. D reads the biometric, generates a BH and uses it to decrypt the password file. If the attempt is successful the password file is decrypted and U is notified of it. U then initiates a short range wireless communication connection to the host terminal using D. On successfully creating a connection, U is notified of this. U then requests for opening the service, by transferring to HT the service attributes and credentials stored on D (CR_{STORED}), via the short range wireless communication. The host terminal, then forwards the credentials to the service provider using the Internet or similar data network. On receiving the credentials from the host terminal, the service provider, uses them to authenticate the user by comparing CR_{STORED} and CR_{SERVICE} (stored when U registered for the service with SP) and accordingly grants or denies access the service. The notification of the result of the authentication is provided to the host terminal only. If successful, the service provider provides the service to the Host terminal.

D after transferring the service attributes to the HT, locks itself to prevent unauthorized access, however it still maintains the short range wireless communication connection it has maintained with the host terminal. The host terminal also maintains this connection with the D. This process is referred to the leash from here on and will be used by both the HT and the D to monitor U's proximity to HT.

The user can now process the service on HT as long as the “leash” is maintained. In the case the leash gets broken (such as U moving away from HT with D) or in any other way, SP will be informed to terminate delivering the service to HT. This information can be communicated either by D or by HT. On receiving this information, the service provider will cease to deliver the service to HT and will require U to authenticate once again (by logging out a user or any embodiment of this action).

Drawing 3 depicts an embodiment of the website based access system with the addition of a Cloud Service (CS) for authentication and with the service delivered by the SP to the HT directly or via the CS. In the case that the service is delivered to the HT via the CS, the access system comprises of the following 18 steps (many of which are common to the embodiment depicted by Drawing 2 and described above):

1. U presents credentials to D either using Biometrics ( ) or Pattern unlock or PIN to access D.
a) If presented with Biometrics, D reads the biometrics.

2. D authenticates U, based on type of credentials/authentication mechanism.
a) If authenticated D unlocks for U.
b) Else asks U to try again.

3. U requests D to open service S by presenting a biometric credential (U_{BIOMETRIC}).

4. D creates BH from U_{BIOMETRICS}.

5. D decrypts CR_{STORED} with BH.

6. U “leashes” himself to Host Terminal (HT) via BT/NFC. (NFC can be used to leash using BT).

7. HT confirms the leash with a success message.

8. D asks HT for HT's Information (port, OS, IP Address, etc.) via D using a secure channel (NFC/BT).

9. HT provides the Terminal Information to D.

10. D requests CS to open S by sending the credentials for service CR_{SERVICE} via a secure channel (MMS, SMS, Wi-Fi) using D. CR_{SERVICE}⊂CR_{STORED}

11. CS forwards only CR_{SERVICE} to SP to authenticate.

12. SP authenticates User based on CR_{SERVICE}

13. SP authenticates/denies U and provides feedback to CS (which will be forwarded to U)

14. If SP grants the access
a. SP provides S to CS
b. CS forwards S to HT.

Otherwise, reject user's access, and the process is terminated.

15. U uses S on HT.

16. D locks itself to prevent misuse. (D can be unlocked via steps 1 and 2)

17. HT and D monitor physical proximity of U via “leash” established in 6.

18. If U moves away from HT either
D requests CS to log off U and terminate connection to HT and CS forwards to SP, to log off U and terminate connection, or
D requests SP to log off U and terminate connection to HT.

Similarly, if the service is provided to the HT directly, the access system comprises of the following 13 steps (many of which are common to the embodiment depicted by Drawing 2 and described above):

1. U presents credentials to D either using Biometrics ( ) or Pattern unlock or PIN to access D.
a) If presented with Biometrics, D reads the biometrics.

2. D authenticates U, based on type of credentials/authentication mechanism.
a) If authenticated D unlocks for U.
b) Else asks U to try again.

3. U requests D to open service S by presenting a biometric credential (U_{BIOMETRICS}).

4. D creates BH from U_{BIOMETRICS}.

5. D decrypts CR_{STORED} with BH.

6. U “leashes” himself to Host Terminal (HT) via BT/NFC. (NFC can be used to leash using BT).

7. HT confirms the leash with a success message.

8. D asks HT for HT's Information (port, OS, IP Address, etc.) via D using a secure channel (NFC/BT).

9. HT provides the Terminal Information to D.

10. D requests CS to open S by sending the credentials for service CR_{SERVICE} via a secure channel (MMS, SMS, Wi-Fi) using D. CR_{SERVICE}⊂CR_{STORED}

11. CS forwards both CRSERVICE and HT information to SP to authenticate.

12. SP authenticates User based on CR_{SERVICE}

13. If SP grants the access, SP provides S to HT. Otherwise, reject user's access, and the process is terminated.

Drawing 4 depicts the web access system where the credentials used by a service provider to authenticate a user is biometrics. The diagram shows the method of registering the biometrics as a credential with a service provider. In this particular embodiment the method of registering consists of the following 14 steps (many of which are common to the embodiment depicted by Drawing 2 and described above):

1. U presents credentials to D either using Biometrics (finger print scanner/FaceUnlock) or Pattern unlock or PIN to access D.
a. If presented with Biometrics, D reads the biometrics.

2. D authenticates U, based on type of credentials/authentication mechanism.
a. If authenticated D unlocks for U.
b. Else asks U to try again.

3. U requests D to create an account/register for a service S with SP using SP's app or our app.

4. D forwards the creation request to SP.

5. SP replies with requests for a Biometric-Hash (BH), Username and Security Questions.

6. U gives Username and answers to the Security Questions (SEC_ANSWER) and presents her biometric credential

7. D reads the user biometric U_{BIOMETRICS}.

8. D creates a biometric hash BH

9. D forwards to SP the Username, SEC_ANSWER and also BH.

10. SP on receiving these values, creates an account for user (which we call service S).

11. SP confirms account creation to D.

12. On receiving the confirmation, D stores the salt used to generate the BH.

13. D confirms account creation to U.

D now locks itself so that no one can log on. (D can be unlocked by using steps 1 and 2)

Drawing 5 depicts the embodiment of using biometrics as credentials to access a web service provided by a service provider. In this embodiment, we assume that user has already registered with the service provider her biometric credentials as per the method illustrated in Drawing 4 and described above. The method for using biometrics as authentication credentials consists of the following 18 steps:

1. U presents credentials to D either using Biometrics (finger print scanner/Face Unlock) or Pattern unlock or PIN to access D.
a. If presented with Biometrics, D reads the biometrics.

2. D authenticates U, based on type of credentials/authentication mechanism.
a. If authenticated D unlocks for U.
b. Else asks U to try again. (After may be 3 tries, phone's contents are purged).

3. U requests D to open service S by presenting a biometric credential (UBIOMETRIC).

4. D reads user biometric UBIOMETRICS.

5. D retrieves the salt used in account creation BH.

6. D generates a biometric hash based on UBIOMETRICS and authenticates U.

7. U “leashes” himself to Host Terminal (HT) via BT/NFC. (NFC can be used to leash using BT).

8. HT confirms the leash with a success message.

9. D asks HT for HT's Information (port, OS, IP Address, etc.) via D using a secure channel (NFC/BT).

10. HT provides the Terminal Information to D.

11. U using D, sends message to SP to open S with credentials (Username and BH) and the Terminal Information to deliver the service to.

12. SP verifies U via credentials.

13. SP authenticates/denies U and thus, grants/denies access to S based on result of Step 12. If SP grants the access, SP forwards S to HT. Otherwise, user access is denied and the process is terminated.

14. SP delivers service to HT.

15. U uses S on HT.

16. D locks itself to prevent any misuse. (D can only be unlocked via steps 1 and 2).

17. HT/D monitors physical proximity of U via “leash” established in 6.

18. If U moves away from HT with D, either
D requests SP to log off U and terminate connection to HT or
HT requests SP to log off U and terminate connection to HT.

In the following section we describe the use of the inventions in scenarios involving Cyber-Physical Entities.

### II. Cyber Physical Entity Access System

In the embodiments of the CPS entity Access system we will use the following basic definitions and notations in addition to the ones described earlier.
CPS entity owner's device (OD).
Reservation request with the reservation starting time, which may either be an instant reservation (if the uses wants to use the CPS entity now) or an advance reservation (if the user wants to use the CPS entity at a later time). It may also contain an finite ending time.

We also describe the general procedure for CPS access system below to highlight the methodology of accessing CPS entities

### General Procedure:

User (human) unlocks her smart device.

The device may communicate with the user agent's device (if there is such an agent) by sending her BH along with a reservation request via NFC. The Owner could be such an agent for the user, and the Owner's smart device could be the user agent's device.

Either the user device or the user agent's device will present users' BH and reservation request to the CPS entity or service's agent, which can be a Reservation System or the owner. NFC is used for communications between the user device, the user agent's device and the CPS entity, unless they are not in a close range for NFC, in which case, a secure channel (e.g., sms, mms, https, SSL, TLS etc.) is used.

Reservation is made by the CPS entity (programmed by itself) or by a service agent (which programs the CPS entity).

When the user presents its smart device to the CPS entity (in a close range via NFC), either the CPS entity or the service's agent can authenticate the user and grant/deny the service. In the latter case of authentication by the service's agent, either the CPS entity can send user's credentials along with its own information, or the user's smart device can send the CPS entity's information along with its own credentials, to the service agent for verification.

All authentication feedback is sent to the CPS entity, based on which the user will either gain or be denied the access.

Drawing 6 depicts the embodiment of the CPS entity access system using a reservation system. In this embodiment a user makes an instant or advance reservation (with optional payment) through a reservation system using her smart device, and presents her smart device and reservation credentials to the resource when accessing the resource. Authentication can be performed either on the spot by the resource, or by the reservation system. In the latter case, either the resource or the user's smart device may send to the reservation system the information needed for authentication verification. An owner can also be considered a user herself when the said owner wants to use the entity herself The methodology of accessing the resource in this embodiment consists of the following 14 steps:

1. U presents credentials to D either using Biometrics (finger print scanner/Faceunlock, etc.) or Pattern unlock to access D.

2. D reads the input and authenticates U, based on type of credentials/authentication mechanism.
a. If authenticated D unlocks for U.
b. Else asks U to try again. (After a few tries, phone's contents are purged).

3. U selects the resource R and enters the desired access time (either instant or advance reservation) and her Biometric.

4. D reads U's biometric (U_{BIOMETRICS}).

5. D creates a BH based on U_{BIOMETRICS}.

6. D sends BH and reservation request information to RS.

7. RS enquires R of service availability.

If there is not availability of service from R the process terminates

8. R confirms availability to RS.

9. Payment scenario:
i. RS sends D the reservation cost details.
ii. D presents U the cost details.
iii. U enters payment method and authorizes transaction for payment.
iv. D sends RS payment details.
v. RS validates U's payment information.

If RS cannot validate U's payment information, the process is terminated (and U is informed via D).

10. RS makes the reservation and confirms to U via D the reservation.

11. U via D requests immediate access to the reserved resource.

12. D generates BH (the same as that generated in step 5) after reading biometric input from U (U_{BIOMETRICs}) and sends it to the resource via NFC to requests access.

13. On the Spot Authentication: R authenticates U by using the supplied BH and other reservation information (such as the reserved access time).

13. (Alternative) Backend Authentication
a. Either Resource to Reservation System Authentication: R sends the supplied BH, along with other reservation information, to RS.
Or User to Reservation System Authentication: (i). D requests R for its information,
(ii). R provides details to D, and (iii). D provides Resource details, along with its BH and other reservation information, to RS.
b. RS authenticates U based on the information provided (including the reserved access time).
c. RS provides R with feedback

14. Based on the authentication result from the previous steps, the resource either grants or denies access to the user.

Drawing 7 depicts the second embodiment of the CPS entity system where the user reserves a resource via the owner (a human) of the resource. The main differences in this embodiment against the previous embodiment are that the user makes the reservation using her smart device through an owner who is also using her smart device and that the authentication is performed on the spot by the resource without involving the owner or the owner's agent. This embodiment also allows the owner to gain access to the resource using the on-the-spot authentication when the owner acts as the resource. The methodology involved in this embodiment consists of the following 14 steps:

1. U presents credentials to D either using Biometrics (finger print scanner/Face unlock, etc.) or Pattern unlock to access D.

2. D reads the input and authenticates U, based on type of credentials/authentication mechanism.
a. If authenticated D unlocks for U.
b. Else asks U to try again. (After a few tries, phone's contents are purged).

3. U selects the resource R and enters the desired access time (either instant or advance reservation) and her Biometric.

4. D reads U's biometric (UBIOMETRICS).

5. D creates a BH based on UBIOMETRICS.

6. D sends BH and reservation request information to OD.

7. OD displays U's information to O and requests for authorization.

8. If O agrees to consider the reservation, O will use OD to take the (optional) payment (as in

Step 9 in the first embodiment of the CPS entity access system, refer to Drawing 7).

If O does not approve the reservation request, the process is terminated (and U is informed via D).

9. If O authorizes the reservation by U, O will use OD to send U's reservation request to R, and makes the reservation.

10. Reservation confirmation using devices.
a. OD confirms to O the reservation.
b. OD also confirms to U via D the reservation. Alternately, O confirms to U in person (orally, in writing, or any other means).

11. U via D requests immediate access to the reserved resource.

12. D generates BH (the same as that generated in step 5) after reading biometric input from U (UBIOMETRICs) and sends it to the resource via NFC to requests access.

13. On the Spot Authentication: R authenticates U by using the supplied BH and other reservation information (such as the reserved access time).

14. Based on the authentication result from the previous steps, the resource either grants or denies access to the user.

Drawing 8 depicts the third embodiment of the CPS entity access system where the user wants to reserve or access a resource via an owner who uses a reservation system. In this particular embodiment, the main difference from the previous two embodiments are that the user makes a reservation through an owner and the owner's smart device, which in turn interfaces with the reservation system. The methodology of accessing the CPS entity in this embodiment consists of the following 15 steps:

1. U presents credentials to D either using Biometrics (finger print scanner/Face unlock, etc.) or Pattern unlock to access D.

2. D reads the input and authenticates U, based on type of credentials/authentication mechanism.
a. If authenticated D unlocks for U.
b. Else asks U to try again. (After a few tries, phone's contents are purged).

3. U selects the resource R and enters the desired access time (either instant or advance reservation) and her Biometric.

4. D reads U's biometric (U_{BIOMETRICS}).

5. D creates a BH based on U_{BIOMETRICS}.

6. D sends BH and reservation request information to OD.

7. OD displays U's information to O and requests for authorization.

8. If O authorizes the reservation, O will use OD to send U's reservation request to RS.

Otherwise, the process terminates (and the U is informed).

9. RS will perform the reservation and optional payment operations as in Steps 7 to 9 in first embodiment of CPS entity Access System, refer to Drawing 6.

10. RS confirms to O the result of the reservation via OD. If the reservation failed, the process will be terminated (and U is informed).

11. User is confirmed the reservation either by D (via OD) or by O in person.

12. U via D requests immediate access to the reserved resource.

13. D generates BH (the same as that generated in step 5) after reading biometric input from U (U_{BIOMETRICS}) and sends it to the resource via NFC to requests access.

14. On the Spot Authentication: R authenticates U by using the supplied BH and other reservation information (such as the reserved access time).

14. (Alternative) Backend Authentication
d. Either Resource to Reservation System Authentication: R sends the supplied BH, along with other reservation information, to RS.
Or User to Reservation System Authentication: (i). D requests R for its information, (ii). R provides details to D, and (iii). D provides Resource details, along with its BH and other reservation information, to RS.
e. RS authenticates U based on the information provided (including the reserved access time).
f. RS provides R with feedback

15. Based on the authentication result from the previous steps, the resource either grants or denies access to the user.

### REFERENCES

[1] A. Adams, M. Sasse, and P. Lunt, “Making passwords secure and usable.” People and Computers, pp. 1-20,1997.

[2] P. Inglesant and M. Sasse, “The true cost of unusable password policies: password use in the wild.” in Proceedings of the 28th international Conf. on Human factors in computing systems. ACM, 2010, pp. 383-392.

[3] R. Shay and E. Bertino, “A comprehensive simulation tool for the analysis of password policies.” International Journal of Information Security, vol. 8, no. 4, pp. 275-289,2009.

[4] J. Stanton, K. Stam, P. Mastrangelo, and J. Jolton, “Analysis of end user security behaviors.” Computers & Security, vol. 24, no. 2, pp. 124-133,2005.

[5] S. Komanduri, R. Shay, P. Kelley, M. Mazurek, L. Bauer, N. Christin, L. Cranor, and S. Egelman, “Of passwords and people: Measuring the effect of password-composition policies.” in Proc. of the 2011 annual Conf. on Human factors in computing systems. ACM, 2011, pp. 2595-2604.

[6] A. Brown, E. Bracken, S. Zoccoli, and K. Douglas, “Generating and remembering passwords.” Applied Cognitive Psychology, vol. 18, no. 6, pp. 641-651,2004.

[7] B. Ives, K. Walsh, and H. Schneider, “The domino effect of password reuse.” Communications of the ACM, vol. 47, no. 4, pp. 75-78,2004.

[8] D. Feldmeier and P. Karn, “Unix password security-ten years later.” In Advances in Cryptology CRYPTO89 Proc. Springer, 1990, pp. 44-63.

[9] Y. Zhang, F. Monrose, and M. K. Reiter, “The security of modern password expiration: an algorithmic framework and empirical analysis.” in Proceedings of the 17th ACM Conf. on Computer and communications security, ser. CCS '10. New York, NY, USA: ACM, 2010, pp. 176-186.

[10] B. Laxton, K. Wang, and S. Savage, “Reconsidering physical key secrecy: Teleduplication via optical decoding.” in Proceedings of the 15th ACM Conf. on Computer and communications security. ACM, 2008, pp. 469-478.

[11] M. Backes, M. Durmuth, and D. Unruh, “Compromising reflections-or how to read lcd monitors around the corner.” in Security and Privacy, 2008. SP 2008. IEEE Symposium on. IEEE, 2008, pp. 158-169.

[12] F. Tari, A. Ozok, and S. Holden, “A comparison of perceived and real shoulder-surfing risks between alphanumeric and graphical passwords.” in Proceedings of the second symposium on Usable privacy and security. ACM, 2006, pp. 56-66.

[13] M. Sasse, S. Brostoff, and D. Weirich, “Transforming the weakest link a human/computer interaction approach to usable and effective security.” BT technology journal, vol. 19, no. 3, pp. 122-131,2001.

What we claim are:

1. An apparatus comprising i). a plurality of smart user devices with one or more biometric sensors to obtain biometric credentials required to enable certain operations on the said smart user device, and a short-distance wireless communications interface; ii). a plurality of display terminals with the said short-distance wireless communications interface to communicate with the said user smart device; and iii). a plurality of remote web servers (or their proxy servers) connected to the Internet, and providing personalized services (e.g., email) that require each of its user to be authenticated first (i.e., supply pre-registered credentials) before granting such services;
a) In a preferred embodiment, the said smart user device is a smartphone with one or more said biometric sensors and the said short-distance wireless communication interface.
b) In one embodiment, the one or more said biometric sensors on the user device are finger-print readers located in the back, on both sides and/or in front of the said user device where a said biometric sensor located in the back reads the prints of the index and/or middle fingers, a said biometric sensor located on the sides reads the prints of all five fingers, and a said biometric sensor located in the front reads the finger print of a thumb.
c) In a preferred embodiment, the said short-distance wireless communications interface is based on the Near-Field Communications (NFC) standards.

2. A method for a user of the said smart user device to first provide a biometric input through the said biometric sensors that matches with the biometric data pre-loaded onto the said smart user device at an earlier time. The said user, after providing the said matching biometric input, is referred to as a biometric-authenticated user of the said smart user device, until the said smart user device is powered down or enters a sleep mode (after being inactive for a specific period of time). The said biometric-authenticated user then operates the said smart user device to i) first connect to the said display terminal using the said short-distance wireless communications interface, and then ii) transmit the said user's credential information, along with the identification (and address information) of a said display terminal and a said web server to the said web server for authentication;
The method further comprising the following step: if and only if the said user credentials are verified to belong to an authorized user by the said web server, the said web server will then deliver the said personalized services to the said user by displaying the said personalized services on the said display terminal.
a) In a preferred embodiment, the said credential information transmitted by the said smart user device is a coded message containing some biometric information of the said user; and the said web server uses the said biometric information to authenticate the said user. In another embodiment, the said credential transmitted by the said smart user device is a coded message containing the account name and password of the said user; and the said web server uses the said account name and password to authenticate the said user.
b) In a preferred embodiment, the said smart user device first communicates with the said display terminal through the said short-distance wireless communications interface to obtain the identification (and address) information of the said display terminal; and subsequently, and the said smart user device then transmits, via a second communication channel, to the said web server, without going through the said display terminal, the said users' credential information along with the said the identification (and address) information of the said display terminal. In another embodiment, the said credential information transmitted by the said smart user device is transmitted first to the said display terminal through the said short-distance wireless communications interface; and subsequently, the said display terminal then relays the said credential information to the said web server, along with the identification (and address) information of the said display terminal, using a third communications channel between the said display terminal and the said web server. The said second and third communications interface need not use different standards.
c) In one embodiment, the said smart user device transmits a coded message containing some biometric information of the said user for accessing the services of a said web server to the said display terminal directly through the said short-distance wireless communications interface; and subsequently, the said display terminal processes (e.g., translates) the received coded message containing some biometric information of the said user to generate another code message containing the account name and password of the said user for the same web server, and finally transmits the said (generated) coded message containing the account name and password of the said user to the said web server through the said third communications channel.

3. The method of claim 2 further comprising a said biometric authenticated user of a said smart user device to use a program installed on the said smart user device to
a) First store (add) the said user's pre-registered credential information for each said web server requiring authentication, either the user's biometric information or a combination of account name and password, on the said smart user device in an encrypted form;
b) Edit or remove the said user's pre-registered credential information for each said web server on the said smart user device, and
c) Transmit the said user's pre-registered credential information for each said web server, either through the said short-distance wireless communications interface to the said display terminal, or through the said second communication channel to the said web server.

4. The method of claim 2 further comprising a said display terminal to
a) First receive the said user's pre-registered credential information for each said web server requiring authentication (as well as any other information pertaining to the said user's request for services which is required by the said web server) through the said short distance wireless communications interface;
b) Run a computer program to communicate with the said web server to obtain the login page of the said web server; and enter the said credential information on the said login page of the said web server;
c) Transmit the login information required by the said web server to the said web server through the said third communications channel;
The said display terminal will then receive, via the said third communication channel, and display the web page from the said web server.

5. The method of claim 2 further comprising a said smart user device to use a fourth wireless communications interface to establish a wireless “leash” connection with a said display terminal;
a) In a preferred embodiment, the said fourth wireless communications interface uses Bluetooth. However, it needs not use a different standard from the said short-distance wireless communication interface, or the said second or third communications interface.
b) The said leash connection between the said smart user device and the said display terminal will be broken if and only if the geographical distance between the two exceeds a threshold value.
c) The web session displayed on the said display terminal will be terminated as soon as the said leash connection is broken.

6. The method of claim 5 further comprising a said smart user device to use a program to control the said fourth wireless communications interface to pre-set and adjust the said threshold value to manage the wireless leash connection with a said display terminal.

7. The method of claim 5 further comprising a said smart user device to use a program to optionally continue to display the web page/session instead of a said display terminal once the said wireless leash connection between the said smart user device and the said display terminal is broken.

8. An apparatus comprising i). a plurality of smart user devices with one or more biometric sensors to obtain biometric credentials required to enable certain operations on the said smart user device, and a short-distance wireless communications interface; ii). a plurality of limited-access devices (or facilities and accounts) with the said short-distance wireless communications interface to communicate with the said user smart device; and iii). a plurality of access-control devices providing authentication/authorization information for a user of the said smart user device to operate the said limited-access devices.
a) In a preferred embodiment, the said smart user device is a smartphone with one or more said biometric sensors and the said short-distance wireless communication interface.
b) In one embodiment, the one or more said biometric sensors on the user device are finger-print readers located in the back, on both sides and/or in front of the said user device where a said biometric sensor located in the back reads the prints of the index and/or middle fingers, a said biometric sensor located on the sides reads the prints of all five fingers, and a said biometric sensor located in the front reads the finger print of a thumb.
c) In a preferred embodiment, the said short-distance wireless communications interface is based on the Near-Field Communications (NFC) standards.
d) In a preferred embodiment, the said limited-access device is a door/entrance to a facility, a lock or an on-off switch to operate a physical object, or an electronic device containing some data or account information that can be accessed/changed only with proper authentication and authorization.
e) In a preferred embodiment, a said smart user device has a second communication interface, in addition to the said short-distance wireless communications interface. The said second communication interface is used by the said smart user device to communications to a said access-control device.
f) In a preferred embodiment, a said limited-access device has a third communication interface, in addition to the said short-distance wireless communications interface. The said third communication interface on the said limited access device needs not use a different standard from the said second communication interface on the said smart user device, and is used by the said limited-access device to communications to a said access-control device.
g) In a preferred embodiment, the said access-control device is a server that provides authentication, authorization and accounting (AAA) services, having the said second communication interface with the said smart user device and the said third communications interface with the said limited-access devices.
h) In one embodiment, the said access-control device is a said smart user device belonging to the owner or manager of the said limited-access device.

9. A method for a user of the said smart user device to first provide a biometric input through the said biometric sensors that matches with the biometric data pre-loaded onto the said smart user device at an earlier time. The said user, after providing the said matching biometric input, is referred to as a biometric-authenticated user of the said smart user device until the said smart user device is powered down or enters a sleep mode (after being inactive for a specific period of time). The said biometric-authenticated user, after making a successful reservation with a said access-control device, and obtaining a confirmation to access a said limited-access device, operates the said smart user device, to connect and communicate to the said limited-access device using the said short-distance wireless communications interface.

10. The method of claim 9 further comprising the following steps:
a) In a preferred embodiment, the said smart user device transmits the said user's credential information (in a coded format) to the said limited-access device using the said short-distance wireless communications interface between them; the said limited-access device receives and processes the said user's credential locally; and if and only if the said user credentials are verified to belong to an authorized user by the said limited-access device, the biometric-authenticated user of the said smart user device is granted the access to the said limited-access device;
b) In another embodiment, either the said smart user device transmits the said user's credential, along with the identification (and address) information of the said limited-access device and the said access-control device, to the said access-control device through the said second communication interface between them, or alternately, the said smart user device transmits the said user's credentials to the said limited-access device using the said short-distance wireless communications interface between them; and then the said limited-access device relays the said access-code and/or the user's credentials, along with its identification (and address) information of the said limited-access device, to the said access-control device through the said third communication interface between them; In either case, the said access-control device processes the received user's credentials, along with the identification (and address) information of the said smart user device, and if and only if the said user's credential is verified to belong to an authorized user by the said access-control device, the said access-control device will send a control signal to the said limited-access device through the said third communications interface between them to grant access to the said biometric-authenticated user of the said smart user device.

11. The method of claim 9 further comprising the said biometric-authenticated user of the said smart user device to operate the said smart user device to
a) Transmit a code message containing the said user's partial or full credential information, along with the identification (and address) information of the said limited-access device and the said access-control device to a said access-control device, as well as other information pertaining to the said user's reservation request, and optionally payment information (for access to a said limited-access device during a specific period of time and for a specific time duration) through the said second communications interface;
b) Receive a confirmation for the said reservation from the said access-control device through the said second communications interface;
c) Transmit the said user's full credential information to either the said limited-access device the said access-control device, as stated in claim 9, to gain the access to the said limited-access device.

12. The method of claim 9 further comprising the said access-control device to receive from any source a reservation request containing a user's partial or full credential information and the identification (and address) information of the said limited-access device and other information pertaining to the reservation (for access to a said limited-access device during a specific period of time and for a specific time duration), and optionally payment information, to reserve the said limited-access device for the said user, and generate a confirmation and send the confirmation to the said source.
a) In one embodiment, the said source is not the same as the said user for whom the reservation is made, and the said source sends the said user's partial credential information only. In another embodiment, the said source is the same as the said user for whom the reservation is made, and the said source sends the said user's partial or full credential information.
b) In a preferred embodiment, the said access-control device transmits the reservation confirmation information to the said limited-access device, along with the said user's partial or full credential information, through the said third communication interface.

13. The method of claim 9 for the first smart user device, belonging to the owner or manager of a said limited-access device, to act as a said access-control device and
a) Receives from any source a reservation request containing a user's partial or full credential information and the identification (and address) information of the said limited-access device and other information pertaining to the reservation (for access to a said limited-access device during a specific period of time and for a specific time duration), and optionally payment information, to reserve the said limited-access device for the said user, and generate a confirmation and send the confirmation to the said source.
c) Receives from the second smart user device a user's access request containing the full credentials of the user of the said second smart user device, along with the identification (and address) information of the said limited-access device, and if and only if the said user's credential is verified to belong to an authorized user by the said first smart user device, the said first smart user device will send a control signal to the said limited-access device to grant access to the said user of the said second smart user device.
